(19) United States
(12) Patent Application Publication
(10) Pub. No.: US 2019/0196218 A1
(43) Pub. Date: Jun. 27, 2019

(54) LIGHTWEIGHT AND BUOYANT EYEGLASSES AND METHOD FOR MANUFACTURING SAME

(71) Applicant: HON HAI PRECISION INDUSTRY CO., LTD., New Taipei (TW)

(72) Inventors: HSIU-WEN CHIEN, New Taipei (TW); WEN-KAI LI, New Taipei (TW)

(21) Appl. No.: 15/956,833

(22) Filed: Apr. 19, 2018

(30) Foreign Application Priority Data
Dec. 26, 2017 (CN) 201711435171.7

(51) Int. Cl. G02C 5/00; G02C 11/00

(52) U.S. Cl. CPC G02C 5/008; G02C 7/12; G02C 11/00; G02C 5/001

(57) ABSTRACT

A lightweight and buoyant eyeglass which floats includes a spectacle frame and two spectacle lenses received in the spectacle frame. The spectacle frame and two spectacle lenses are made from a same material, cyclic block copolymer is a main component of the material.

### FIELD

The subject matter herein generally relates to optical aids.

### BACKGROUND

During water sports or even face washing, your eyeglasses may fall into the water and be difficult to find.

### BRIEF DESCRIPTION OF THE DRAWINGS

Implementations of the present technology will now be described, by way of example only, with reference to the attached figures.

FIG. 1 is an isometric view of lightweight and buoyant eyeglasses including a pair of spectacle lenses, according to a first embodiment.

FIG. 2 is a cross-sectional view of a spectacle lens of FIG. 1 in accordance with one exemplary embodiment.

FIG. 3 is a cross-sectional view of a spectacle lens of FIG. 1 in accordance with one exemplary embodiment.

FIG. 4 is a cross-sectional view of a spectacle lens of FIG. 1 in accordance with one exemplary embodiment.

FIG. 5 is a flowchart for manufacturing the lightweight and buoyant eyeglass in FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale, and the proportions of certain parts may be exaggerated to illustrate details and features of the present disclosure better. The disclosure is illustrated by way of example and not by way of limitation in the figures of the accompanying drawings, in which like references indicate similar elements. It should be noted that references to “an” or “one” embodiment in this disclosure are not necessarily to the same embodiment, and such references mean “at least one.”

Several definitions that apply throughout this disclosure will now be presented.

The term “substantially” is defined to be essentially conforming to the particular dimension, shape, or other feature that the term modifies, such that the component need not be exact. For example, “substantially cylindrical” means that the object resembles a cylinder, but can have one or more deviations from a true cylinder. The term “comprising,” when utilized, means “including, but not necessarily limited to”; it specifically indicates open-ended inclusion or membership in the so-described combination, group, series, and the like. The references “a plurality of” and “a number of” mean “at least two.”

### Example 1

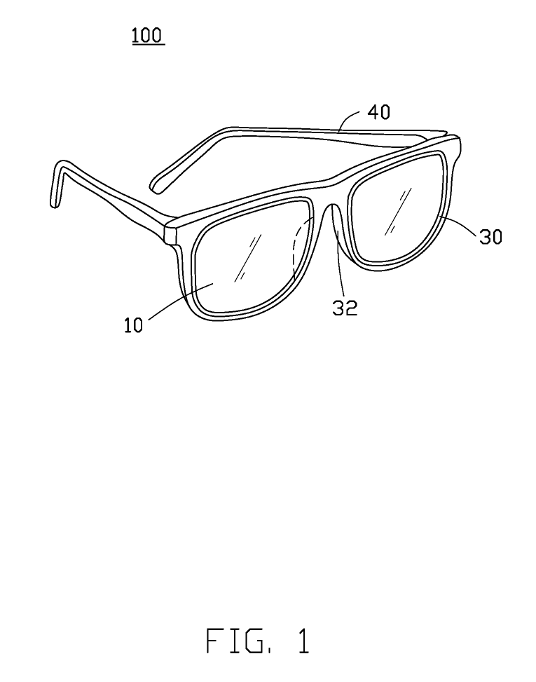

FIG. 1 illustrates a lightweight and buoyant eyeglass 100 according to one embodiment. The lightweight and buoyant eyeglass 100 includes a spectacle frame 30, two nose supports 32 formed with the spectacle frame 30, and two eyeglass legs 40 connecting with the spectacle frame 30. Two spectacle lenses 10 are received in the spectacle frame 30. The spectacle frame 30, the two spectacle lenses 10, the nose supports 32, and the two eyeglass legs 40 are made from a same material, a main component of the material is cyclic block copolymer (CBC). This material allows the lightweight and buoyant eyeglass 100 to be buoyant in water and lightweight.

In a preferred embodiment, ultraviolet absorber is doped into the circular block copolymers to form ultraviolet absorbing properties, especially to form the spectacle lenses 10. A weight ratio of the ultraviolet absorber in a total weight of the circular block copolymers and the ultraviolet absorbers is between 0.0003% and 5.8%. This allows the lightweight and buoyant eyeglass 100 to have strongly block ultraviolet light.

In a preferred embodiment, a compound is doped into the circular block copolymers to increase strength and impact resistance of the lightweight and buoyant eyeglass 100, and the compound has a mass percentage between about 0.0023% to about 47.64% of a total mass of the compound and cyclic block copolymer.

The compound is selected from a group consisting of graphene, carbon nanotube, polycarbonate, and any combination there lightweight and buoyant.

The spectacle lens 10 can be single focus, bi-focus, or multi-focus lens.

The spectacle lenses 10 can be employed as corrective lens, such as myopia lens, hypermetropia lenses, presbyopic lens, or progressive lens.

### Example 2

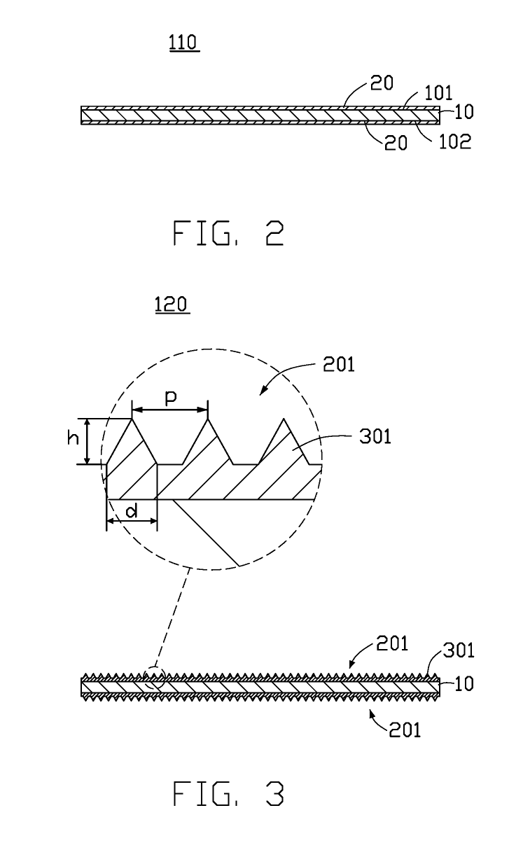

FIG. 2 is a cross-sectional view of the spectacle lens 10 in accordance with one exemplary embodiment. In the illustrated embodiment, the spectacle lens 10 includes a front surface 101 and a rear surface 102 opposite to the front surface 101. A functional film 20 is formed on both the front surface 101 and the rear surface 102.

The front surface 101 is can be a spherical surface, a non spherical surface, or a progressive surface. The back surface 102 can be a spherical surface, an aspheric surface, or a progressive surface.

The functional film 20 is select from a group consisting of a rigid film, an anti-smear film (to reduce fingerprints), an anti fogging film, a color film, a waterproof self cleaning film, an anti ultraviolet film, and an anti reflection film, or any combination thereof. That is, a rigid film, an anti-smear film, an anti fogging film, a color film, a waterproof self cleaning film, an anti ultraviolet film, and an anti reflection film can be successively formed on one surface of the lens main body 10 according to the functional requirements.

### Example 3

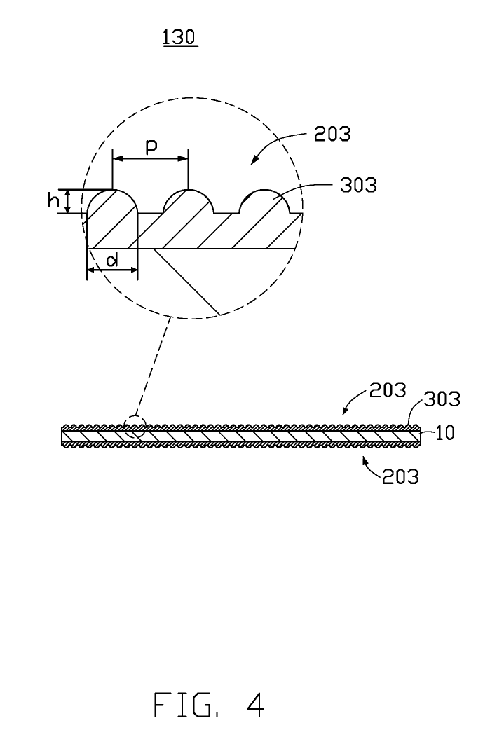

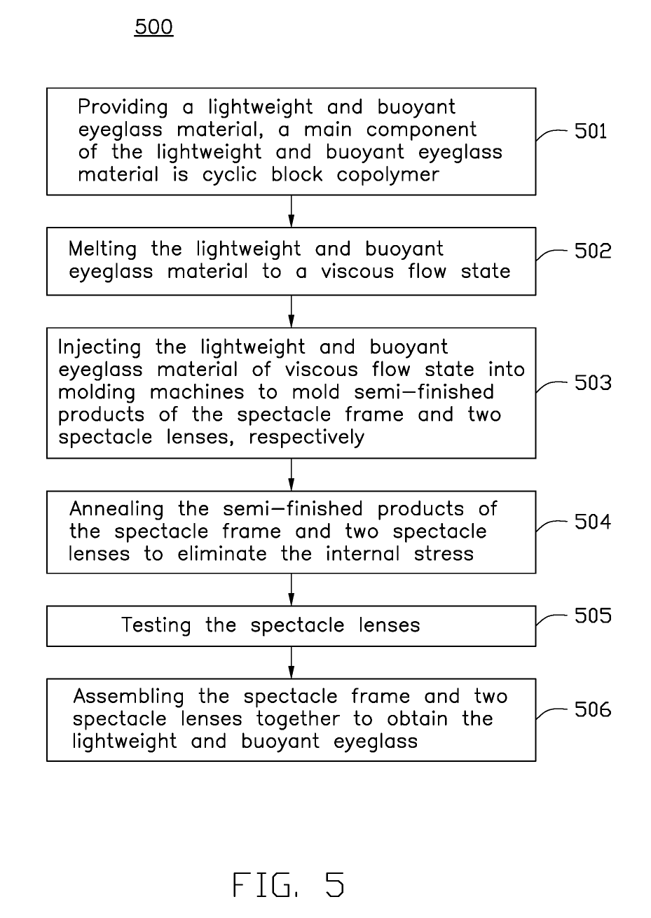

FIG. 3 illustrates a spectacle lens 120 according to one embodiment. The spectacle lens 120 in FIG. 3 is similar to the spectacle lens 110 in FIG. 2. The difference between the spectacle lens 120 and the spectacle lens 110 in FIG. 2 is that the functional film includes an anti reflection film 201. The anti reflection film 201 includes a plurality of micro-structures 301 spaced apart, and the size of the microstructure 301 is of nanometer magnitude.

In the illustrated embodiment, as shown in FIG. 3, a section of the microstructure 301 is triangular. A height of the microstructure 301 is in a range from 40 nm to 550 nm, a width of the microstructure 301 is in a range from 35 nm to 555 nm, and a period of the microstructures 301 is in a range from 10 nm to 650 nm. The scale of microstructure is no greater than the wavelength of light.

When the scale of the microstructure 301 is not larger than the wavelength of light, refraction of a light wave will present a continuous change on the surface of the microstructure (gradations of gradual index of refraction), and this continuous change can achieve the anti reflection characteristics and increase the light-absorption of optical structures. Thereby, the microstructures 301 are able to absorb light from all and any direction. The surface of the anti-reflection film 201 including a plurality of the microstructure 301 means that the spectacle lens 120 has super-hydrophobicity and self-cleaning properties, similarly to that of the lotus flower.

FIG. 4 illustrates a spectacle lens 130 according to one embodiment. The spectacle lens 130 in FIG. 4 is similar to the lightweight spectacle lens 120 in FIG. 3. The difference between the lightweight spectacle lens 130 and the lightweight spectacle lens 120 in FIG. 3 is that a section of the microstructure 303 is semicircular.

FIG. 5 illustrates a method for manufacturing lightweight and buoyant eyeglass according to one embodiment. The method is provided by way of example as there are a variety of ways to carry out the method 500. The method 500 can begin at block 501.

At block 501, as shown in FIG. 5, an lightweight and buoyant eyeglass material is provided. A main component of the lightweight and buoyant eyeglass material is cyclic block copolymer.

In other embodiment, ultraviolet absorber is doped into the circular block copolymers to form ultraviolet absorbing properties, especially to form the spectacle lenses 10. A weight ratio of the ultraviolet absorber in a total weight of the circular block copolymers and the ultraviolet absorbers is between 0.0003% and 5.8%. This allows the lightweight and buoyant eyeglass 100 to have strongly block ultraviolet light.

In other embodiment, a compound is doped into the circular block copolymers to increase strength and impact resistance of the lightweight and buoyant eyeglass 100, and the compound has a mass percentage between about 0.0023% to about 47.64% of a total mass of the compound and cyclic block copolymer.

The compound is selected from a group consisting of graphene, carbon nanotube, polycarbonate, and any combination there lightweight and buoyant.

At block 502, the lightweight and buoyant eyeglass material is melted to a viscous flow state.

At block 503, the lightweight and buoyant eyeglass material of viscous flow state is injected into molding machines to mold semi-finished products of the spectacle frame and two spectacle lenses.

At block 504, the semi-finished products of the spectacle frame and two spectacle lenses are annealed to eliminate internal stress.

At block 505, quality of the spectacle lenses 10 are tested.

In a preferred embodiment, a functional film 20 is formed on at least one surface of the spectacle lens 10. The functional film 20 is selected from a group consisting of a rigid film, an anti-smear film, an anti fogging film, a color film, a waterproof self cleaning film, and an anti reflection film, or any combination thereof. If the functional film comprises an anti reflection film 20, the anti reflection film 20 is formed on the surface of the eyeglass 100 by a sol-gel method.

At block 506, the spectacle frame and two spectacle lenses are assembled together to obtain the lightweight and buoyant eyeglass 100 of the disclosure.

The embodiments shown and described above are only examples. Therefore, many commonly-known features and details are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size, and arrangement of the parts within the principles of the present disclosure, up to and including the full extent established by the broad general meaning of the terms used in the claims. It will, therefore, be appreciated that the embodiments described above may be modified within the scope of the claims.

What is claimed is:

1. A lightweight and buoyant eyeglass, comprising:
a spectacle frame and two spectacle lenses are received in the spectacle frame, wherein the spectacle frame and two spectacle lenses are made from a same material, and a main component of the material is cyclic block copolymer.

2. The lightweight and buoyant eyeglass of claim 1, wherein the lightweight and buoyant eyeglass further comprises a nose support forming with the spectacle frame, wherein the nose support is made from cyclic block copolymer.

3. The lightweight and buoyant eyeglass of claim 1, wherein the lightweight and buoyant eyeglass further comprises two eyeglass legs connecting with the spectacle frame, and the two eyeglass legs are made from cyclic block copolymer.

4. The lightweight and buoyant eyeglass of claim 1, wherein an ultraviolet absorbers is doped into the circular block copolymers to form an anti-ultraviolet glasses, and a weight ratio of the ultraviolet absorbers in a total weight of the circular block copolymers and the ultraviolet absorbers is 0.0003% and 5.8%.

5. The lightweight and buoyant eyeglass of claim 1, wherein the ultraviolet absorbers is select from UV-326, UV-329, or UV-531.

6. The lightweight and buoyant eyeglass of claim 1, wherein a compound is doped into the circular block copolymers to increase strength of the lightweight and buoyant eyeglass, and the compound has a mass percentage between about 0.0023% to about 47.64% of a total mass of the compound and cyclic block copolymer.

7. The lightweight and buoyant eyeglass of claim 1, wherein the compound is selected from a group consisting of graphene, carbon nanotube, polycarbonate and any combination thereof.

8. The lightweight and buoyant eyeglass of claim 1, wherein each spectacle lens further comprises a functional film formed on at least one surfaces of the spectacle lens, the functional film is select from a group consisting of a rigid film, an anti-smear film, an anti fogging film, a color film, a waterproof self cleaning film, and an anti reflection film or any combination thereof.

9. The lightweight and buoyant eyeglass of claim 1, wherein the functional film comprises an anti reflection film, the anti reflection film comprises a plurality of micro-structures spacing apart, and the size of the microstructure is in nanometer magnitude.

10. The lightweight and buoyant eyeglass of claim 1, wherein a section of the microstructure is triangular or semicircular.

11. The lightweight and buoyant eyeglass of claim 1, wherein a height of the microstructure is in a range from 40 nm to 550 nm, a width of the microstructure is in a range from 35 nm to 555 nm, a period of the microstructures is in a range from 10 nm to 650 nm.

12. A method for manufacturing a lightweight and buoyant eyeglass, comprising:
providing a lightweight and buoyant eyeglass material, a main component of the lightweight and buoyant eyeglass material is cyclic block copolymer;
melting the lightweight and buoyant eyeglass material to a viscous flow state;
injecting the lightweight and buoyant eyeglass material of viscous flow state into molding machines to mold semi-finished products of the spectacle frame and two spectacle lenses, respectively;
annealing the semi-finished products of the spectacle frame and two spectacle lenses to eliminate the internal stress;
testing the spectacle lenses; and
assembling the spectacle frame and two spectacle lenses together to obtain the lightweight and buoyant eyeglass.

13. The method of claim 12, wherein in the step of providing a lightweight and buoyant eyeglass material, an ultraviolet absorbers is doped into the circular block copolymer, and a weight ratio of the ultraviolet absorbers in a total weight of the circular block copolymers and the ultraviolet absorbers is 0.0003% and 5.8%.

14. The method of claim 13, wherein the ultraviolet absorbers is select from a group consisting of UV-326, UV-329, UV-531 and any combination there of.

15. The method of claim 12, wherein in the step of providing a lightweight and buoyant eyeglass material, a compound is doped into the circular block copolymers to increase strength of the lightweight and buoyant eyeglass, and the compound has a mass percentage between about 0.0023% to about 47.64% of a total mass of the compound and cyclic block copolymer.

16. The method of claim 15, wherein after the step of testing the spectacle lenses, further comprises a step of forming a functional film on at least one surfaces of the spectacle lens, the functional film is select from a group consisting of a rigid film, an anti-smear film, an anti fogging film, a color film, a waterproof self cleaning film, and an anti reflection film or any combination thereof.

17. The method of claim 16, wherein the functional film comprises an anti reflection film, the anti reflection film is formed by a sol-gel method.

18. The method of claim 17, wherein the functional film comprises a plurality of micro-structures spacing apart, and the size of the microstructure is in nanometer magnitude.

19. The method of claim 18, wherein a section of the microstructure is triangular or semicircular.

20. The method of claim 19, wherein a height of the microstructure is in a range from 40 nm to 550 nm, a width of the microstructure is in a range from 35 nm to 555 nm, a period of the microstructures is in a range from 10 nm to 650 nm.
